(19) United States
(12) Patent Application Publication
(10) Pub. No.: US 2025/0156554 A1
(43) Pub. Date: May 15, 2025

(54) IMAGE PROCESSING APPARATUS, BACKUP STORAGE METHOD, AND NON-TRANSITORY COMPUTER-READABLE RECORDING MEDIUM

(71) Applicant: Konica Minolta, Inc., Tokyo (JP)

(72) Inventors: Kazuhiro TOMIYASU, Toyokawa-shi (JP); Hiroshi SUGIURA, Toyokawa-shi (JP)

(21) Appl. No.: 18/937,677

(22) Filed: Nov. 5, 2024

(30) Foreign Application Priority Data
Nov. 13, 2023 (JP) 2023-192743

(51) Int. Cl. G06F 21/57; G06F 11/14

(52) U.S. Cl. CPC G06F 21/577; G06F 11/1469; G06F 2221/033

(57) ABSTRACT

An image processing apparatus includes: a first storage section that stores multiple pieces of firmware to be started in stages; a second storage section that stores firmware selected from the multiple pieces of firmware as a backup; and a hardware processor. The hardware processor detects tampering of each of the multiple pieces of firmware stored in the first storage section, and restores the tampered firmware by using the firmware stored in the second storage section in a case where the tampering of the firmware stored in the first storage section is detected. The hardware processor selects, according to an apparatus state, the firmware to be stored as backup in the second storage section.

### CROSS REFERENCE TO RELATED APPLICATIONS

The present application is based on Japanese Patent Application No. 2023-192743 filed on Nov. 13, 2023, the contents of which are incorporated herein by reference.

### BACKGROUND OF THE INVENTION

### Technical Field

The present invention relates to an image processing apparatus, a backup storage method, and a non-transitory computer-readable recording medium.

### Description of the Related Art

In an image processing apparatus such as a multifunction peripheral (MFP), a technique for detecting whether firmware has been tampered with at the time of activation is known (for example, Japanese Patent Literature No. JP2020-82441A and Japanese Patent Literature No. JP2023-64046A). These conventional image processing apparatuses store backup data of firmware separately from firmware for activation. Upon detecting tampering with the firmware for activation at the time of starting the firmware, the image processing apparatus restores the firmware from the backup data and starts using the restored firmware.

However, in a case where all firmware installed in the image processing apparatus is stored in a duplicated manner for activation and for backup, it is necessary to install a storage device having a sufficient storage capacity in the image processing apparatus, which leads to an increase in cost. For this reason, the above-described conventional technique cannot be applied to an image processing apparatus, such as a low-priced image processing apparatus, which does not have a sufficient storage capacity for storing all firmware in a duplicated manner, and cannot execute appropriate processing when the firmware for activation is tampered.

In addition, a storage device such as a hard disk drive (HDD) or a solid-state drive (SSD) mounted in the image processing apparatus may be added to the image processing apparatus as an option or removed from the image processing apparatus. In particular, if the storage device is removed in a state where all firmware is stored in a duplicated manner in the image processing apparatus, it may be impossible to secure a storage capacity sufficient to store the firmware in a duplicated manner.

Furthermore, the data amount of the firmware may increase due to the update of the firmware. Therefore, a case can occur where although the image processing apparatus has duplicated stored the firmware before the firmware is updated, a storage capacity sufficient for duplicated storing the firmware cannot be ensured due to the firmware being updated.

On the other hand, a method is conceivable in which the firmware is not duplicated and stored, but the firmware is acquired from the external device via a network and updated. However, depending on a user environment in which the image processing apparatus is installed, it may not be allowed to acquire the firmware from the external device via the network. If tampering with the firmware is detected in such a state, the image processing apparatus cannot externally obtain and update the firmware and thus cannot recover the firmware.

### SUMMARY OF THE INVENTION

The present invention has been devised in order to solve the above-described conventional problems. That is, an object of the present invention is to enable appropriate processing to be performed at the time of firmware tampering while effectively utilizing a storage area by automatically switching firmware to be stored for backup in accordance with an apparatus state. The present invention provides an image processing apparatus, a backup holding method, and a non-transitory computer-readable recording medium storing a program that can achieve such an object.

In order to achieve the above object, first, the present invention is directed to an image processing apparatus.

According to one aspect of the present invention, the image processing apparatus includes: a first storage section that stores multiple pieces of firmware to be started in stages; a second storage section that stores firmware selected from the multiple pieces of firmware as a backup; and a hardware processor that: detects tampering of each of the multiple pieces of firmware stored in the first storage section, and restores the tampered firmware by using the firmware stored in the second storage section in a case where the tampering of the firmware stored in the first storage section is detected, wherein the hardware processor selects, according to an apparatus state, the firmware to be stored as backup in the second storage section.

Second, the present invention is also directed to a method for storing firmware as a backup in an image processing apparatus that includes: a first storage section that stores multiple firmware to be started up in stages; a second storage section that stores, as a backup, a firmware selected from among the multiple firmware; and a hardware processor that detects tampering with each of the multiple firmware stored in the first storage section and, upon detection of tampering with a firmware, restores the tampered firmware using the firmware stored in the second storage section.

According to one aspect of the present invention, the method includes: selecting, from among the multiple firmware, firmware to be stored as a backup in the second storage section in accordance with an apparatus state; and changing firmware stored as backup in the second storage section according to the selection result.

Third, the present invention is also directed to a non-transitory computer-readable recording medium storing a program executed in an image processing apparatus that includes: a first storage section that stores multiple firmware to be started up in stages; a second storage section that stores, as a backup, a firmware selected from among the multiple firmware; and a hardware processor that detects tampering with each of the multiple firmware stored in the first storage section and, upon detection of tampering with a firmware, restores the tampered firmware using the firmware stored in the second storage section.

In one aspect of the present invention, the program causes the hardware processor to perform: selecting, from among the multiple firmware, firmware to be stored as a backup in the second storage section in accordance with an apparatus state; and changing firmware stored as backup in the second storage section according to the selection result.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an example of a conceptual configuration of a network system including an image processing apparatus;

FIG. 2 is a block diagram illustrating an example of a hardware configuration of an image processing apparatus;

FIG. 3 is a block diagram illustrating a functional configuration of a controller;

FIG. 4 is a flowchart illustrating an example of a processing procedure by a security chip;

FIG. 5 is a flowchart illustrating an example of a processing procedure performed by a setter of a basic operation controller;

FIG. 6 is a flowchart illustrating an example of a main processing procedure performed by the firmware update section;

FIG. 7 is a flowchart illustrating an example of a detailed processing procedure of the firmware update processing;

FIG. 8 is a flowchart illustrating an example of a detailed processing procedure of the backup holding determination;

FIG. 9 is a flowchart illustrating an example of a detailed processing procedure of the backup change processing;

FIGS. 10A, 10B and 10C are conceptual drawings illustrating some examples of backup storage aspects of firmware;

FIG. 11 is a flowchart illustrating a processing procedure in which the firmware update section acquires the firmware from the server apparatus;

FIG. 12 is a flowchart illustrating an example of a processing procedure performed by a start processing section when firmware for a legitimate OS cannot be started;

FIG. 13 illustrates an example of a notification screen displayed on the display section; and

FIG. 14 is a block diagram illustrating the functional configuration of a controller in the second embodiment;

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, preferred embodiments of the present invention will be described in detail with reference to the drawings. Note that elements common to the embodiments described below are denoted by the same reference signs, and redundant description thereof is omitted.

### First Embodiment

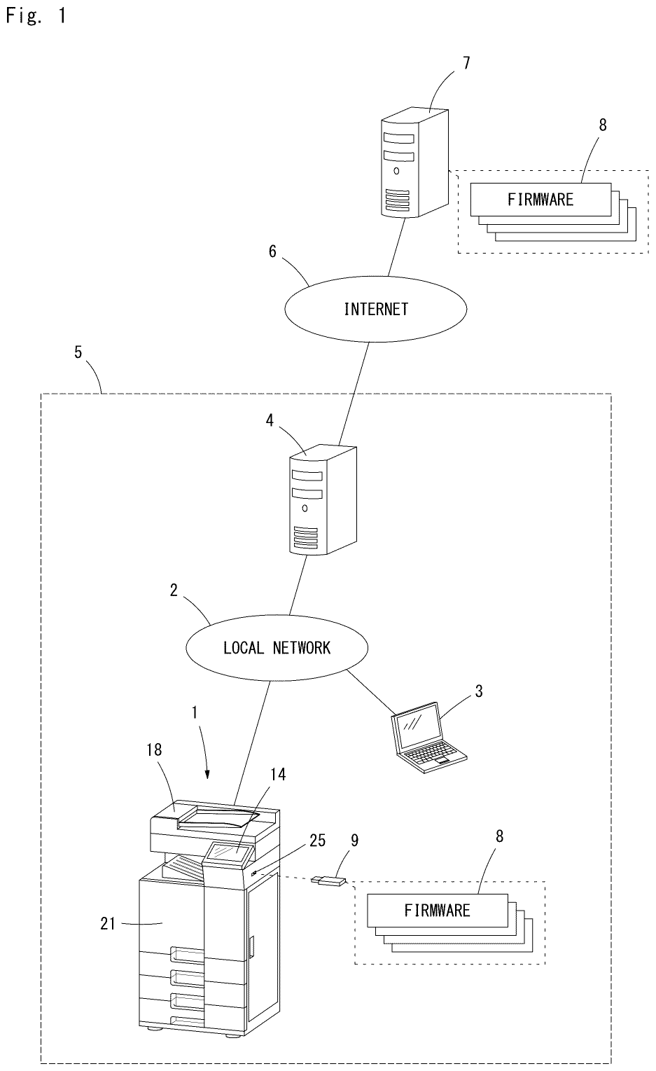

FIG. 1 illustrates a conceptual configuration example of a network system including an image processing apparatus 1 according to an embodiment of the present invention. The network system includes an image processing apparatus 1 installed in an office environment 5 of a user. The image processing apparatus 1 is configured by an MFP, for example. The image processing apparatus 1 has multiple functions such as a scan function, a print function, and a copy function, and executes a job specified by a user.

The image processing apparatus 1 includes an operation panel 14, a scanner section 18, and a printer section 21. The operation panel 14 is a user interface for a user to use the image processing apparatus 1. A user can perform job setting and the like by operating the operation panel 14. The scanner section 18 operates during execution of a scan job or a copy job. The scanner section 18 generates image data by reading an image of a document set by a user. The printer section 21 operates when a print job or a copy job is executed. The printer section 21 forms and outputs an image on a sheet such as a print sheet based on image data to be printed.

The image processing apparatus 1 is connected to a local network 2 provided in an office environment 5. In addition to the image processing apparatus 1, an information processing apparatus 3 such as a personal computer (PC) and a proxy server 4 are connected to the local network 2. For example, the image processing apparatus 1 can transmit image data generated by executing a scan job to the information processing apparatus 3 via the local network 2. Furthermore, upon receiving a print job transmitted from the information processing apparatus 3 via the local network 2, the image processing apparatus 1 executes the print job, forms an image on a sheet, and outputs the sheet.

The proxy server 4 connects the local network 2 to the Internet 6, which is an external network. A server apparatus 7, which is an external apparatus, is connected to the Internet 6. The server apparatus 7 holds the firmware 8 for the image processing apparatus 1 and provides the image processing apparatus 1 with the latest firmware 8 when requested by the image processing apparatus 1. Therefore, when the image processing apparatus 1 is permitted to access the external server apparatus 7 via the proxy server 4, the image processing apparatus 1 can update its own firmware 8 by downloading the latest firmware 8 from the server apparatus 7. The firmware 8 is a computer-readable program, and is a dedicated program for the image processing apparatus 1.

On the other hand, in a case where the security of the office environment 5 is strict, the image processing apparatus 1 may be prohibited from accessing the external server apparatus 7 via the proxy server 4. In such a case, the image processing apparatus 1 cannot access the server apparatus 7 to download the firmware 8. Therefore, the image processing apparatus 1 is provided with an external apparatus connection interface 25 for connecting the external apparatus 9 such as a USB memory. When the external apparatus 9 such as a USB memory is attached to the external apparatus connection interface 25, the image processing apparatus 1 can acquire the firmware 8 stored in the external apparatus 9 and update the firmware 8 of the image processing apparatus 1.

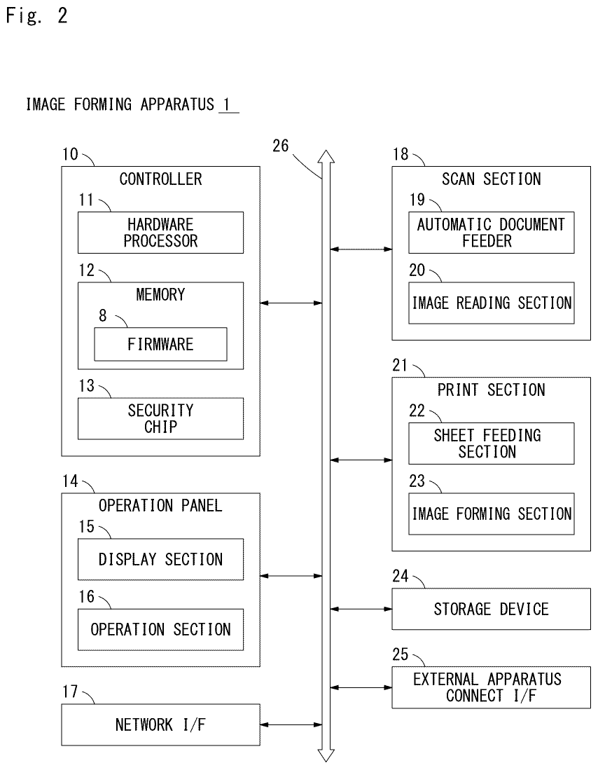

FIG. 2 is a block diagram illustrating an example of a hardware configuration of the image processing apparatus 1. The image processing apparatus 1 includes a controller 10, an operation panel 14, a network interface 17, a scanner section 18, a printer section 21, a storage device 24, and an external apparatus connection interface 25. The image processing apparatus 1 has a configuration in which these sections are connected to a bus 26, and the sections can input and output data to and from each other via the bus 26.

The controller 10 comprehensively controls the operation of the image processing apparatus 1. The controller 10 includes a hardware processor 11, a memory 12, and a security chip 13. For example, the hardware processor 11, the memory 12, and the security chip 13 are mounted on one substrate. The hardware processor 11 reads and executes the firmware 8 stored in the memory 12. Thus, the hardware processor 11 controls the operation of each part of the image processing apparatus 1. The memory 12 is a nonvolatile storage device that stores the firmware 8. For example, the memory 12 is configured by a non-volatile random-access memory (NVRAM) or the like. The memory 12 can also store data other than the firmware 8. The security chip 13 is a chip that inspects whether the firmware 8 stored in the memory 12 is legitimate firmware. The security chip 13 is capable of detecting tampering with the firmware 8.

The operation panel 14 includes a display section 15 and an operation section 16. The display section 15 is formed with, for example, a color liquid crystal display, and displays various operation screens that can be operated by a user. The operation section 16 is formed with, for example, touch screen keys arranged on the display screen of the display section 15, and receives a user operation.

The network interface 17 connects the image processing apparatus 1 to the local network 2. The image processing apparatus 1 communicates with an external apparatus via the network interface 17.

The scanner section 18 includes an automatic document feeder (ADF) 19 and an image reading section 20. The automatic document feeder 19 takes out a document located at the top of multiple documents set by a user one by one, and automatically conveys the document to a reading position of the image reading section 20. The image reading section 20 optically reads an image of the document when the document conveyed by the automatic document feeder 19 passes through a reading position, and generates image data. The image reading section 20 is also capable of reading an image of a document placed on the platen glass.

The printer section 21 includes a sheet feeding section 22 and an image forming section 23. The sheet feeding section 22 holds multiple sheets such as printing sheets, and takes out and conveys the uppermost sheet one by one from the multiple sheets. The image forming section 23 forms an image on a surface of the sheet when the sheet conveyed by the sheet feeding section 22 passes through a predetermined position.

The storage device 24 is a non-volatile storage device, for example, a hard disk drive or a solid-state drive. The storage device 24 can store image data, job data, and the like. The storage device 24 may also temporarily store the firmware 8 acquired from the outside.

The external apparatus connection interface 25 is an interface for attaching the external apparatus 9 such as a USB memory as described above.

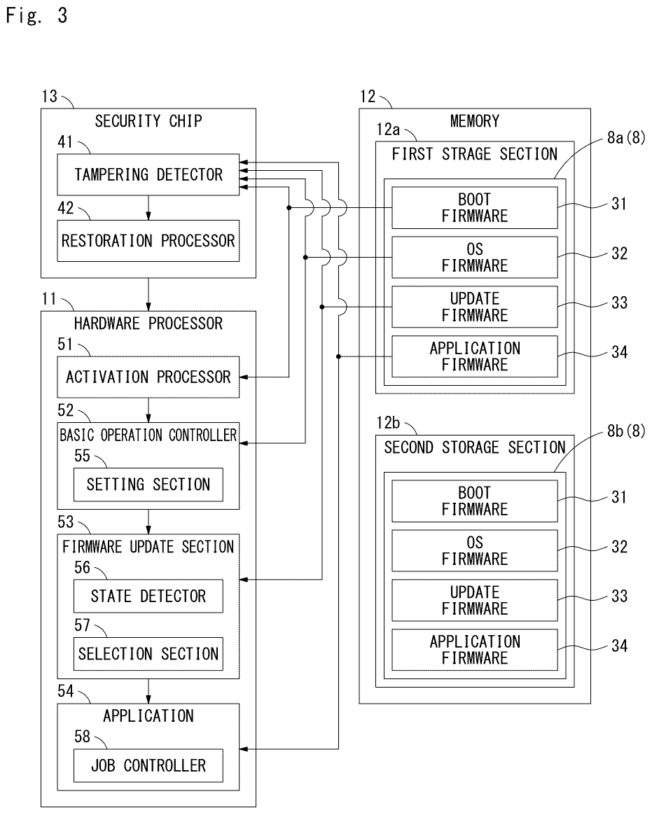

FIG. 3 is a block diagram illustrating a functional configuration of the controller 10. As illustrated in FIG. 3, the memory 12 includes a first storage section 12a and a second storage section 12b. The memory 12 stores the same firmware 8 in each of the first storage section 12a and the second storage section 12b. That is, the image processing apparatus 1 store the firmware 8 in the memory 12 in a duplicated manner.

The first storage section 12a is a storage area that stores start-up firmware 8a to be executed by the hardware processor 11. The firmware 8a includes boot firmware 31, OS firmware 32, update firmware 33, and application firmware 34. The boot firmware 31 is firmware that is executed first when the image processing apparatus 1 is activated, and is firmware for activating the OS firmware 32. The OS firmware 32 is basic software of the image processing apparatus 1 and controls basic operation of the image processing apparatus 1. When the OS firmware 32 is normally activated by the hardware processor 11, the OS firmware 32 sequentially activates the update firmware 33 and the application firmware 34. The update firmware 33 is software that executes processing for updating the firmware 8. The application firmware 34 is software that controls execution of a job in the image processing apparatus 1. The multiple firmware 31, 32, 33, and 34 are activated in stages in the hardware processor 11.

The second storage section 12b is a storage area different from the first storage section 12a, and is a storage area for storing firmware 8b for backup. Similarly to the firmware 8a, the firmware 8b includes boot firmware 31, OS firmware 32, update firmware 33, and application firmware 34. However, the firmware 8b stored in the second storage section 12b may not include all of the boot firmware 31, the OS firmware 32, the update firmware 33, and the application firmware 34. Except when the firmware 31, 32, 33, and 34 for backup is rewritten, a write prohibition setting is given to the second storage section 12b. Therefore, the firmware 31, 32, 33, and 34 for backup, stored in the second storage section 12b is not tampered during the normal operation of the image processing apparatus 1.

The security chip 13 operates immediately after the image processing apparatus 1 is powered on, and determines whether the firmware 8a stored in the first storage section 12a has been tampered with. The security chip 13 includes a tampering detector 41 and a restoration processor 42.

The tampering detector 41 functions when the image processing apparatus 1 is activated. The tampering detector 41 sequentially checks whether each of the boot firmware 31, the OS firmware 32, the update firmware 33, and the application firmware 34 included in the firmware 8a has been tampered with.

First, the tampering detector 41 checks whether the boot firmware 31 stored in the first storage section 12a has been tampered with. For example, the tampering detector 41 checks the presence or absence of tampering by signature verification or the like. Signature verification is a method of performing verification by decrypting encrypted information included in a signature with a public key and determining whether the decrypted value matches a predetermined hash value. When the boot firmware 31 is legitimate firmware, the decrypted value matches the predetermined hash value. In contrast, in a case where the boot firmware 31 has been tampered with, the decrypted value does not match the predetermined hash value. Therefore, if the boot firmware 31 has been tampered with, the tampering detector 41 can detect the tampering with the boot firmware 31.

If the boot firmware 31 has not been tampered with, the tampering detector 41 allows the hardware processor 11 to start the boot firmware 31. As a result, the hardware processor 11 reads the boot firmware 31 from the first storage section 12a and starts the boot firmware 31.

On the other hand, when tampering with the boot firmware 31 is detected, the tampering detector 41 brings the restoration processor 42 into operation. The restoration processor 42 deletes the boot firmware 31 in the first storage section 12a. After deleting the boot firmware 31 from the first storage section 12a, the restoration processor 42 copies the boot firmware 31 in the second storage section 12b to the first storage section 12a. Upon completion of the copying of the boot firmware 31, the restoration processor 42 permits the hardware processor 11 to activate the boot firmware 31. As a result, the hardware processor 11 reads the boot firmware 31 from the first storage section 12a and starts the boot firmware 31.

While the boot firmware 31 is being activated in the hardware processor 11, the tampering detector 41 checks whether the OS firmware 32 stored in the first storage section 12a has been tampered with. This verification method is the same as the verification method of the boot firmware 31.

When the OS firmware 32 is not tampered, the tampering detector 41 permits the hardware processor 11 to activate the OS firmware 32. Accordingly, the hardware processor 11 reads the OS firmware 32 from the first storage section 12a and starts the OS firmware 32.

On the other hand, when tampering with the OS firmware 32 is detected, the tampering detector 41 brings the restoration processor 42 into operation. The restoration processor 42 deletes the OS firmware 32 in the first storage section 12a. After deleting the OS firmware 32 from the first storage section 12a, the restoration processor 42 copies the OS firmware 32 in the second storage section 12b to the first storage section 12a. When the copying of the OS firmware 32 is completed, the restoration processor 42 permits the hardware processor 11 to activate the OS firmware 32. Accordingly, the hardware processor 11 reads the OS firmware 32 from the first storage section 12a and starts the OS firmware 32.

While the activation processing of the OS firmware 32 is being performed in the hardware processor 11, the tampering detector 41 checks whether the update firmware 33 and the application firmware 34 stored in the first storage section 12a have been tampered. These verification methods are the same as the verification method for the boot firmware 31.

If the update firmware 33 has not been tampered with, the tampering detector 41 permits the hardware processor 11 to activate the update firmware 33. Accordingly, the hardware processor 11 reads the update firmware 33 from the first storage section 12a and starts the update firmware 33.

In contrast, if tampering with the update firmware 33 is detected, the tampering detector 41 brings the restoration processor 42 into operation. The restoration processor 42 deletes the update firmware 33 in the first storage section 12a. After deleting the update firmware 33 from the first storage section 12a, the restoration processor 42 copies the update firmware 33 in the second storage section 12b to the first storage section 12a. When the copying of the update firmware 33 is completed, the restoration processor 42 permits the hardware processor 11 to activate the update firmware 33. Accordingly, the hardware processor 11 reads the update firmware 33 from the first storage section 12a and starts the update firmware 33.

If the application firmware 34 has not been tampered with, the tampering detector 41 permits the hardware processor 11 to activate the application firmware 34. As a result, the hardware processor 11 reads the application firmware 34 from the first storage section 12a and starts the application firmware 34.

On the other hand, when tampering with the application firmware 34 is detected, the tampering detector 41 brings the restoration processor 42 into operation. The restoration processor 42 deletes the application firmware 34 in the first storage section 12a. After deleting the application firmware 34 from the first storage section 12a, the restoration processor 42 copies the application firmware 34 in the second storage section 12b to the first storage section 12a. Upon completion of the copying of the application firmware 34, the restoration processor 42 permits the hardware processor 11 to activate the application firmware 34. As a result, the hardware processor 11 reads the application firmware 34 from the first storage section 12a and starts the application firmware 34.

Therefore, when the security chip 13 detects tampering of the firmware 31, 32, 33, and 34 of the first storage section 12a to be activated, the security chip 13 can restore and activate the firmware 31, 32, 33, and 34 from the second storage section 12b for backup.

The hardware processor 11 sequentially activates the multiple firmware 31, 32, 33, and 34 to function as an activation processor 51, a basic operation controller 52, a firmware update section 53, and an application 54.

The activation processor 51 functions when the hardware processor 11 activates the boot firmware 31. The activation processor 51 performs processing for activating the OS firmware 32 in the hardware processor 11.

The basic operation controller 52 functions when the hardware processor 11 activates the OS firmware 32. The basic operation controller 52 controls basic operation of the image processing apparatus 1. The basic operation controller 52 includes a setting section 55.

The setting section 55 performs various settings related to the basic operation of the image processing apparatus 1. For example, when the image processing apparatus 1 is brought into the office environment 5 and is activated for the first time, the setting section 55 functions and receives various setting operations related to the basic operation from the user. Then, the setting section 55 generates and holds the setting information related to the basic operation based on the setting operation of the user. The basic operation controller 52 controls the basic operation of the image processing apparatus 1 based on the setting information. The setting information is information whose setting can be appropriately changed by the user.

The setting information stored in the setting section 55 includes a setting as to whether to allow the image processing apparatus 1 to access the external server apparatus 7 via the proxy server 4. When access to the external server apparatus 7 is permitted in the setting information, the image processing apparatus 1 can access the server apparatus 7 and download the firmware 8 stored in the server apparatus 7. On the other hand, when access to the external server apparatus 7 is prohibited in the setting information, the basic operation controller 52 prohibits the image processing apparatus 1 from accessing the external server apparatus 7. Therefore, the image processing apparatus 1 cannot download and acquire the firmware 8 from the server apparatus 7.

The firmware update section 53 functions when the hardware processor 11 activates the update firmware 33. The firmware update section 53 updates the firmware 8a for activation stored in the first storage section 12a. The firmware update section 53 generates a firmware 8b for backup from the firmware 8a for activation stored in the first storage section 12a, and stores the firmware 8b in the second storage section 12b. Details of the processing by the firmware update section 53 will be described later.

The application 54 functions when the hardware processor 11 activates the application firmware 34. The application 54 controls the operation of each part of the image processing apparatus 1 via the basic operation controller 52. The application 54 includes a job controller 58.

The job controller 58 causes the display section 15 of the operation panel 14 to display a job setting screen via the basic operation controller 52. The job controller 58 also acquires operation information based on a user's operation on the job setting screen via the basic operation controller 52. The job controller 58 makes settings for the job based on the operation information. In addition, the job controller 58 controls execution of a job in the image processing apparatus 1 based on operation information instructing start of execution of the job. Therefore, when the application 54 is normally activated in the hardware processor 11, the image processing apparatus 1 becomes ready to execute a job.

Next, update and backup of the firmware 8 in the image processing apparatus 1 will be described in detail.

For example, when access to the external server apparatus 7 is permitted, the firmware update section 53 periodically accesses the server apparatus 7. Upon accessing the server apparatus 7, the firmware update section 53 determines whether the version of the firmware 8 stored in the server apparatus 7 has been updated. When the firmware 8 has been updated by version upgrade or the like, the firmware update section 53 downloads the latest firmware 8 from the server apparatus 7. The downloaded firmware 8 is temporarily stored in, for example, the storage device 24. Then, the firmware update section 53 deletes the firmware 8a stored in the first storage section 12a at an appropriate update timing of the firmware 8, and stores the firmware 8 downloaded from the server apparatus 7 in the first storage section 12a. As the update timing of the firmware 8, for example, there is a timing at which a restart is instructed by the user.

Further, the firmware update section 53 monitors whether the external apparatus 9 such as a USB memory is attached to the external apparatus connection interface 25. Upon detection of attachment of the external apparatus 9, the firmware update section 53 determines whether the firmware 8 is stored in the external apparatus 9. As a result, when the firmware 8 is stored in the external apparatus 9, the firmware update section 53 performs version determination. If the version of the firmware 8 stored in the external apparatus 9 is newer than the version of the firmware 8a stored in the first storage section 12a, the firmware update section 53 reads the firmware 8 of the external apparatus 9 and temporarily stores it in the storage device 24. Thereafter, the firmware update section 53 deletes the firmware 8a stored in the first storage section 12a at an appropriate update timing of the firmware 8, and stores the firmware 8 acquired from the external apparatus 9 in the first storage section 12a.

On the other hand, when access to the external server apparatus 7 is prohibited, the firmware update section 53 does not access the external server apparatus 7. In this case, the firmware update section 53 acquires the latest firmware 8 from the external apparatus 9 attached to the external apparatus connection interface 25, and updates the firmware 8a in the first storage section 12a.

The firmware update section 53 includes a state detector 56 and a selection section 57. The state detector 56 and the selection section 57 function when the backup firmware 8b is stored in the second storage section 12b.

The state detector 56 detects an apparatus state of the image processing apparatus 1. The state detector 56 detects the storage amount of the second storage section 12b as the apparatus state. The state detector 56 also detects the apparatus state based on the setting information held by the setting section 55. For example, the state detector 56 detects, as the apparatus state, whether access to the external server apparatus 7 is permitted or prohibited in the setting information.

The selection section 57 selects firmware to be stored as a backup in the second storage section 12b in accordance with the apparatus state detected by the state detector 56. That is, the selection section 57 selects the firmware to be stored as backup from among the boot firmware 31, the OS firmware 32, the update firmware 33, and the application firmware 34. Then, based on the selection result by the selection section 57, the firmware update section 53 generates a firmware 8b for backup from the firmware 8a for activation stored in the first storage section 12a, and stores the firmware 8b in the second storage section 12b.

Therefore, the image processing apparatus 1 of the present embodiment switches the firmware 8b stored as a backup in the second storage section 12b according to the apparatus state. For example, when the memory 12 is added as an option in the image processing apparatus 1, the storage capacity of the memory 12 increases. In contrast, when the memory 12 added as an option is removed from the image processing apparatus 1, the storage capacity of the memory 12 is reduced. Therefore, the apparatus state of the image processing apparatus 1 changes due to the addition or removal of the memory 12. In this case, the selection section 57 determines whether a storage area necessary for storing the firmware 8b for backup can be secured as the second storage section 12b based on the storage size of the memory 12. The selection section 57 selects the firmware to be stored in the second storage section 12b for backup from among the multiple firmware 31, 32, 33, and 34 based on the determination result.

Furthermore, when the firmware 8 is updated by version upgrade or the like, the amount of data of the firmware 8 may increase. In this case, since the amount of the first storage section 12a in the memory 12 increases, the storable area of the second storage section 12b inevitably decreases. Therefore, the apparatus state of the image processing apparatus 1 changes. The selection section 57 selects the firmware to be stored in the second storage section 12b for backup from among the multiple firmware 31, 32, 33, and 34 based on the amount of the firmware 8 and the storable area of the second storage section 12b.

In addition, from the viewpoint of attaching importance to security, there is a case where a setting in which access to the external server apparatus 7 is permitted in the image processing apparatus 1 is changed and access to the external server apparatus 7 is prohibited. Also in this case, the apparatus state of the image processing apparatus 1 changes. Therefore, the selection section 57 selects the firmware to be stored in the second storage section 12b for backup from among the multiple firmware 31, 32, 33, and 34 according to the setting of permission or prohibition of access to the server apparatus 7.

When the second storage section 12b can store all of the multiple firmware 31, 32, 33, and 34, the selection section 57 selects all of the pieces of firmware 31, 32, 33, and 34 as the backup targets. In this case, the firmware update section 53 reads all of the multiple pieces of firmware 31, 32, 33, and 34 stored in the first storage section 12a and copies them to the second storage section 12b. As a result, all of the multiple pieces of firmware 31, 32, 33, and 34 stored in the first storage section 12a are stored in the second storage section 12b as a backup. When the firmware update section 53 stores the firmware 31, 32, 33, and 34 in the second storage section 12b, the firmware update section 53 gives a write prohibition setting to the second storage section 12b. As a result, the firmware update section 53 prevents the firmware 31, 32, 33, and 34 stored in the second storage section 12b from being tampered with.

When all the pieces of firmware 31, 32, 33, and 34 are stored in the second storage section 12b as a backup, the image processing apparatus 1 can restore the four pieces of firmware 31, 32, 33, and 34 from the backup. Therefore, even if any of the four pieces of firmware 31, 32, 33, and 34 is tampered with, the image processing apparatus 1 can be normally activated by the legitimate firmware 31, 32, 33, and 34. That is, the image processing apparatus 1 can normally activate the activation processor 51, the basic operation controller 52, the firmware update section 53, and the application 54.

In contrast, the storage space of the second storage section 12b might not be able to store all of the multiple firmware 31, 32, 33, and 34. In this case, the selection section 57 determines whether the firmware 31, 32, and 33 except for the application firmware 34 can be stored in the second storage section 12b. That is, the selection section 57 determines whether the boot firmware 31, the OS firmware 32, and the update firmware 33 that are necessary for acquiring the firmware 8 from the server apparatus 7 can be stored in the second storage section 12b. As a result, when the firmware 31, 32, and 33 can be stored in the second storage section 12b, the selection section 57 selects the boot firmware 31, the OS firmware 32, and the update firmware 33 as backup targets. In this case, the firmware update section 53 reads the boot firmware 31, the OS firmware 32, and the update firmware 33 stored in the first storage section 12a and copies the read firmware to the second storage section 12b. As a result, the boot firmware 31, the OS firmware 32, and the update firmware 33 stored in the first storage section 12a are stored in the second storage section 12b as a backup. When the firmware update section 53 stores the firmware 31, 32, and 33 in the second storage section 12b, the firmware update section 53 gives a write prohibition setting to the second storage section 12b. As a result, the firmware update section 53 prevents the three pieces of firmware 31, 32, and 33 stored in the second storage section 12b from being tampered with.

When the three pieces of firmware 31, 32, and 33 are stored as backups in the second storage section 12b, the image processing apparatus 1 can restore the three pieces of firmware 31, 32, and 33 from the backups. Therefore, even if any one of the three firmware 31, 32, and 33 is tampered with, the image processing apparatus 1 can be normally activated with the legitimate firmware 31, 32, and 33. That is, the image processing apparatus 1 can normally activate the activation processor 51, the basic operation controller 52, and the firmware update section 53.

However, when the application firmware 34 in the first storage section 12a has been tampered with, the restoration processor 42 cannot restore the application firmware 34 using the firmware 8b in the second storage section 12b. In this case, the restoration processor 42 instructs the firmware update section 53 to download the legitimate application firmware 34 from the server apparatus 7. The firmware update section 53 accesses the server apparatus 7 and downloads the legitimate application firmware 34 based on the instruction from the restoration processor 42. Then, the firmware update section 53 stores the application firmware 34 downloaded from the server apparatus 7 in the first storage section 12a. Thus, the application firmware 34 is recovered to a normal state in which the application firmware 34 has not been tampered.

However, when access to the server apparatus 7 is prohibited in the setting information, the firmware update section 53 cannot download the legitimate application firmware 34 from the server apparatus 7. That is, even if the application firmware 34 in the first storage section 12a is tampered with, the image processing apparatus 1 cannot immediately restore the application firmware 34 to a normal state. Therefore, when access to the server apparatus 7 is prohibited, it is useless to store the three pieces of firmware 31, 32, and 33 as backup in the second storage section 12b in order to download the firmware 8 from the server apparatus 7 and restore the firmware 8.

Therefore, when all of the multiple firmware 31, 32, 33, and 34 cannot be stored in the second storage section 12b and access to the server apparatus 7 is prohibited, the image processing apparatus 1 stores only the minimum firmware as a backup. In this case, the selection section 57 selects only the boot firmware 31 as a backup target from among the multiple pieces of firmware 31, 32, 33, and 34. Then, the firmware update section 53 reads only the boot firmware 31 from the first storage section 12a and stores the boot firmware 31 in the second storage section 12b. Thus, it is possible to prevent the storage area of the memory 12 from being occupied by unnecessary backup firmware 8b. As a result, the image processing apparatus 1 can effectively use the storage capacity of the memory 12 and store more data besides the firmware 8 in the memory 12.

Here, when the OS firmware 32 cannot be normally activated in the hardware processor 11, the activation processor 51 executes a processing of displaying a notification screen indicating that the firmware 8 has been tampered on the display section 15 of the operation panel 14. That is, the boot firmware 31 includes a module that causes, when the OS firmware 32 cannot be normally activated, such a notification screen to be displayed. Therefore, when the image processing apparatus 1 is activated, if the basic operation controller 52 does not function normally after the activation processor 51 functions in the hardware processor 11, a notification screen by the activation processor 51 is displayed on the display section 15. This notification screen allows the user to know that the firmware 8 has been tampered with and the image processing apparatus 1 will not start up normally. Therefore, the user can take appropriate measures such as immediately making a service person call.

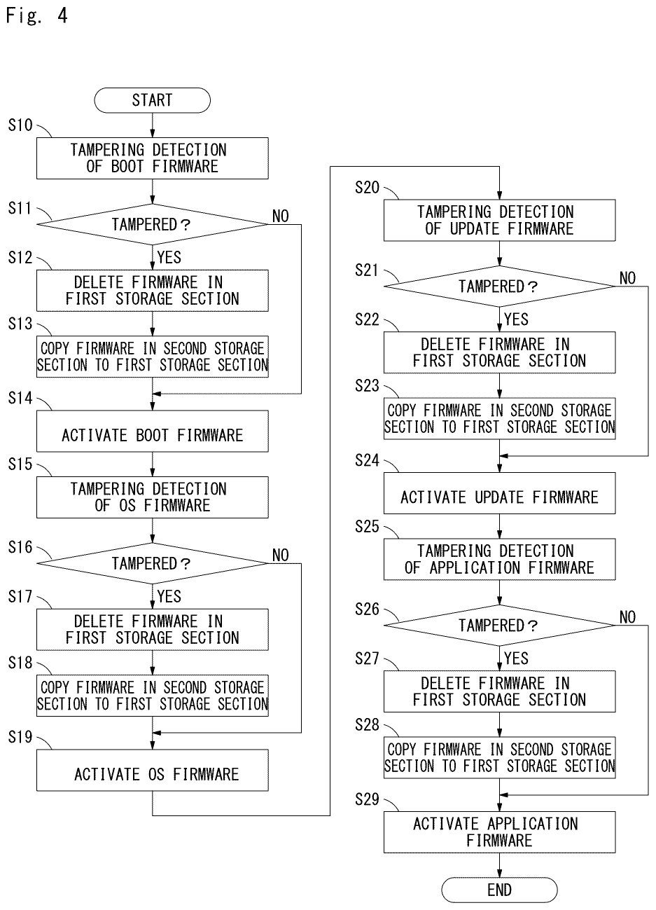

Next, the operation of the image processing apparatus 1 will be described. FIG. 4 is a flowchart illustrating an example of a processing procedure by the security chip 13. The processing procedure illustrated in FIG. 4 is started with power on of the image processing apparatus 1.

When the image processing apparatus 1 is powered on, the security chip 13 causes the tampering detector 41 to function. Then, the tampering detector 41 detects whether the boot firmware 31 stored in the first storage section 12a has been tampered with (step S10). As a result, when tampering of the boot firmware 31 is detected (YES in step S11), the security chip 13 brings the restoration processor 42 into operation. The restoration processor 42 reads the boot firmware 31 from the second storage section 12b (step S12). Then, the restoration processor 42 overwrites the boot firmware 31 in the first storage section 12a with the boot firmware 31 read from the second storage section 12b (step S13). As a result, the boot firmware 31 in the first storage section 12a is replaced with normal firmware that has not been tampered with. If tampering of the boot firmware 31 is not detected (NO in step S11), the processing in steps S12 and S13 is not performed. Thereafter, the security chip 13 causes the hardware processor 11 to activate the boot firmware 31 (step S14). Thus, the boot firmware 31 in the first storage section 12a is activated in the hardware processor 11, and the activation processor 51 functions.

The security chip 13 causes the tampering detector 41 to function again. Then, the tampering detector 41 detects whether the OS firmware 32 stored in the first storage section 12a has been tampered with (step S15). As a result, when tampering of the OS firmware 32 is detected (YES in step S16), the security chip 13 brings the restoration processor 42 into operation. The restoration processor 42 reads the OS firmware 32 in the second storage section 12b (step S17). Then, the restoration processor 42 overwrites the OS firmware 32 in the first storage section 12a with the OS firmware 32 read from the second storage section 12b (step S18). As a result, the OS firmware 32 in the first storage section 12a is replaced with normal firmware that has not been tampered with. If tampering of the OS firmware 32 is not detected (NO in step S16), the processing of steps S17 and S18 are not performed. Thereafter, the security chip 13 causes the hardware processor 11 to activate the OS firmware 32 (step S19). Thus, the OS firmware 32 in the first storage section 12a is activated in the hardware processor 11, and the basic operation controller 52 functions.

The security chip 13 causes the tampering detector 41 to function again. Next, the tampering detector 41 detects whether the update firmware 33 stored in the first storage section 12a has been tampered with (step S20). As a result, when tampering of the update firmware 33 is detected (YES in step S21), the security chip 13 causes the restoration processor 42 to function. The restoration processor 42 reads the update firmware 33 in the second storage section 12b (step S22). Next, the restoration processor 42 overwrites the update firmware 33 in the first storage section 12a with the update firmware 33 read from the second storage section 12b (step S23). As a result, the update firmware 33 in the first storage section 12a is replaced with normal firmware that has not been tampered with. If tampering of the update firmware 33 is not detected (NO in step S21), the processing of steps S22 and S23 are not performed. Thereafter, the security chip 13 causes the hardware processor 11 to activate the update firmware 33 (step S24). Accordingly, the update firmware 33 of the first storage section 12a is activated in the hardware processor 11, and the firmware update section 53 functions.

The security chip 13 causes the tampering detector 41 to function again. Then, the tampering detector 41 detects whether the application firmware 34 stored in the first storage section 12a has been tampered with (step S25). As a result, when tampering of the application firmware 34 is detected (YES in step S26), the security chip 13 brings the restoration processor 42 into operation. The restoration processor 42 reads the application firmware 34 in the second storage section 12b (step S27). Then, the restoration processor 42 overwrites the application firmware 34 in the first storage section 12a with the application firmware 34 read from the second storage section 12b (step S28). As a result, the application firmware 34 in the first storage section 12a is replaced with normal firmware that has not been tampered with. When tampering of the application firmware 34 is not detected (NO in step S26), the processing of steps S27 and S28 are not performed. Thereafter, the security chip 13 causes the hardware processor 11 to activate the application firmware 34 (step S29). Thus, the application firmware 34 in the first storage section 12a is activated in the hardware processor 11, and the application 54 functions.

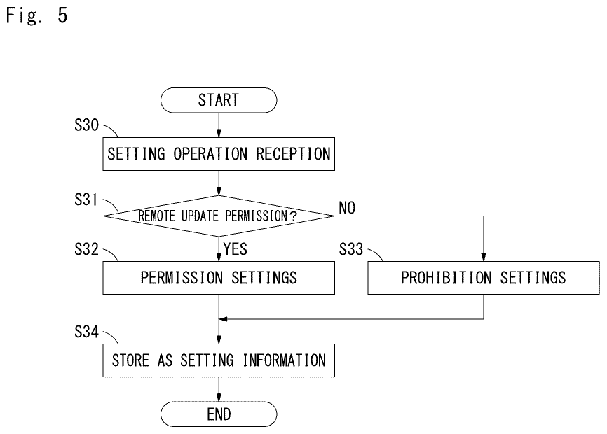

Next, FIG. 5 is a flowchart illustrating an example of a processing procedure performed by the setting section 55 of the basic operation controller 52. This processing is started, for example, when the basic operation controller 52 is functioning in the hardware processor 11 and no setting information is stored. Furthermore, this processing is also started in a case where a change operation of the setting information is performed by the user in a state where the basic operation controller 52 is functioning.

When this processing is started, the setting section 55 receives a setting operation by the user (step S30). Then, the setting section 55 determines whether the remote update for downloading and updating the firmware 8 from the server apparatus 7 has been permitted by the user (step S31). If remote update is permitted (YES in step S31), the setting section 55 makes a setting to permit access to the server apparatus 7 to acquire the firmware 8 (step S32). On the other hand, in a case where the remote update is not permitted (NO in step S31), the setting section 55 performs setting for prohibiting the firmware 8 from being acquired from the server apparatus 7 (step S33). Thereafter, the setting section 55 stored the setting content set in step S32 or S33 as setting information (step S34).

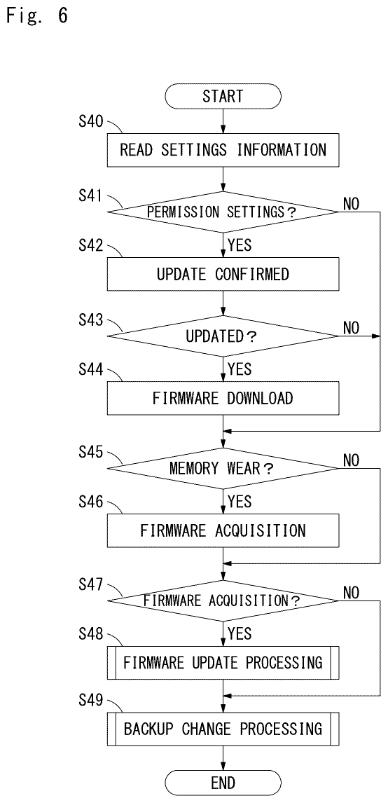

Next, FIGS. 6 to 9 are flowcharts illustrating an example of a processing procedure performed by the firmware update section 53. This processing is periodically executed by the firmware update section 53. When starting this processing, the firmware update section 53 reads the setting information stored by the setting section 55 (step S40). The firmware update section 53 determines, based on the setting information, whether acquisition of the firmware 8 from the server apparatus 7 is permitted (step S41). If the firmware 8 is permitted to be acquired from the server apparatus 7 (YES in step S41), the firmware update section 53 accesses the server apparatus 7. Next, the firmware update section 53 checks whether the firmware 8 stored in the server apparatus 7 has been updated (step S42). When the firmware 8 of the server apparatus 7 has been updated (YES in step S43), the firmware update section 53 downloads the firmware 8 from the server apparatus 7 (step S44). In a case where the firmware 8 is prohibited from being acquired from the server apparatus 7 (NO in step S41), the processing of steps S42 to S44 are not performed. When the firmware 8 of the server apparatus 7 has not been updated (NO in step S43), the processing of step S44 is not performed.

The firmware update section 53 determines whether the external apparatus 9 such as a USE memory has been attached to the external apparatus connection interface 25 (step S45). When the external apparatus 9 is attached (YES in step S45), the firmware update section 53 reads and acquires the firmware 8 stored in the external apparatus 9 (step S46). The firmware update section 53 acquires the firmware 8 from the external apparatus 9 when the version of the firmware 8 stored in the external apparatus 9 is newer than the version of the firmware 8a stored in the first storage section 12a. If the external apparatus 9 is not attached to the external apparatus connection interface 25 (NO in step S45), the processing of step S46 is not performed.

The firmware update section 53 determines whether the firmware 8 has been acquired from the server apparatus 7 or the external apparatus 9 (step S47). If the firmware 8 has been acquired (YES in step S47), the firmware update section 53 executes firmware update processing (step S48). If the firmware 8 has not been acquired (NO in step S47), the processing of step S48 is not performed.

Next, the firmware update section 53 performs backup change processing (step S49). The firmware 8b stored as a backup in the second storage section 12b may be changed by the backup change processing.

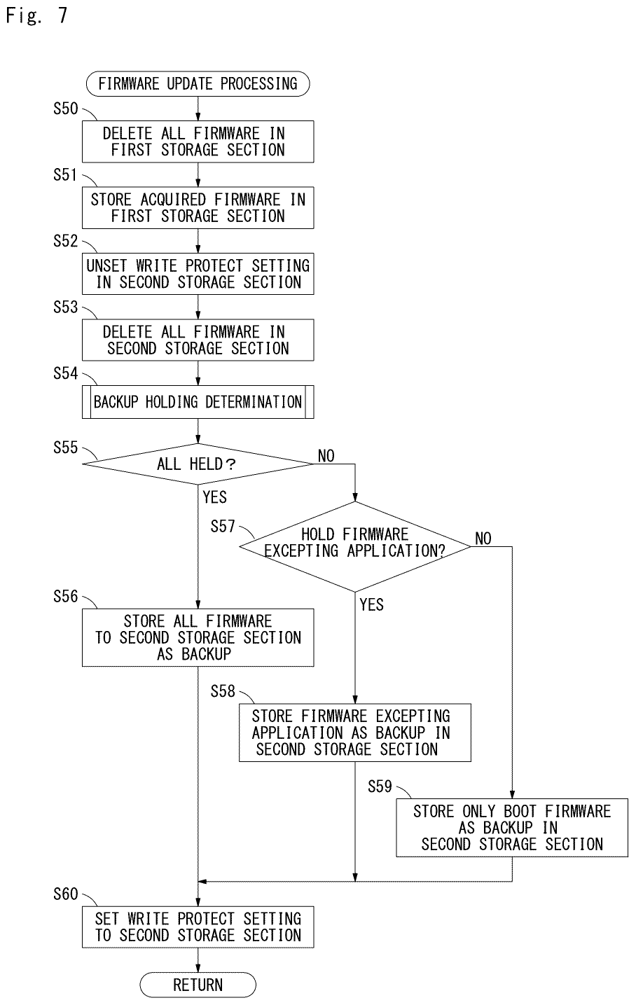

FIG. 7 is a flowchart illustrating an example of a detailed processing procedure of firmware update processing (step S48). When starting this processing, the firmware update section 53 deletes all the firmware 31, 32, 33, and 34 stored in the first storage section 12a (step S50). When all of the firmware 31, 32, 33, and 34 are deleted, the firmware update section 53 stores the firmware 8 acquired from the server apparatus 7 or the external apparatus 9 in the first storage section 12a (step S51). Thus, the latest versions of the boot firmware 31, the OS firmware 32, the update firmware 33, and the application firmware 34 are stored in the first storage section 12a.

When the firmware 8a of the first storage section 12a is updated, the firmware update section 53 releases the write prohibition setting of the second storage section 12b (step S53). After releasing the writing prohibition setting, the firmware update section 53 deletes all the firmware 8b stored in the second storage section 12b (step S53). Thereafter, the firmware update section 53 causes the state detector 56 and the selection section 57 to function, and executes the backup holding determination (step S54).

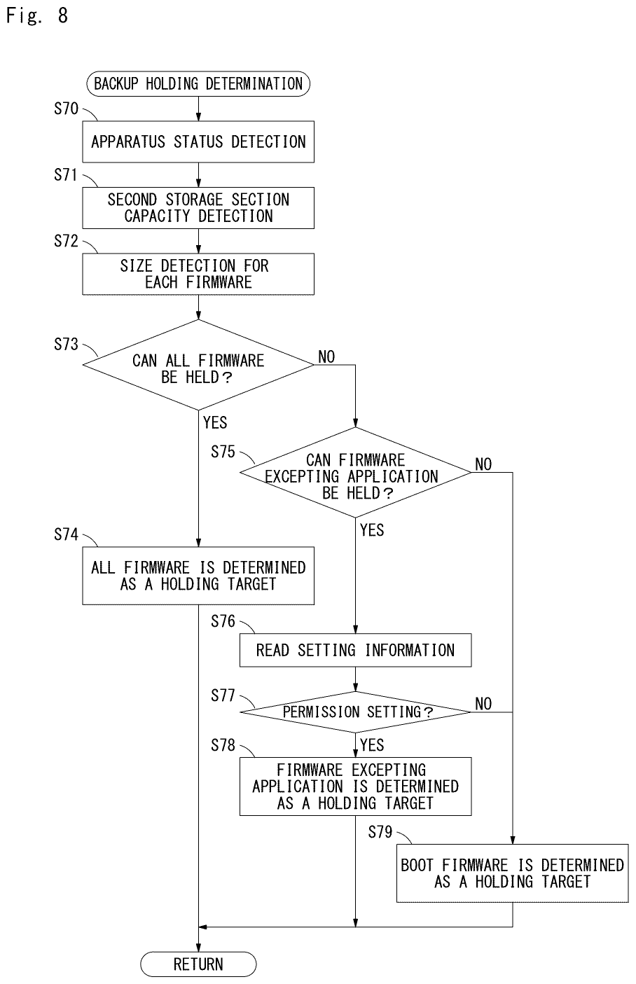

FIG. 8 is a flowchart illustrating an example of a detailed processing procedure of backup holding determination (step S54). First, the firmware update section 53 brings the state detector 56 into operation to detect the apparatus state of the image processing apparatus 1 (step S70). Next, the state detector 56 detects a free space in the second storage section 12b for storing the firmware 8b for backup (step S71). Subsequently, the state detector 56 detects the data size of each of the firmware 31, 32, 33, and 34 stored in the first storage section 12a (step S72).

Next, the firmware update section 53 brings the selection section 57 into operation. The selection section 57 determines whether all of the multiple pieces of firmware 31, 32, 33, and 34 stored in the first storage section 12a can be held in the second storage section 12b (step S73). If all the pieces of firmware 31, 32, 33, and 34 can be held as backups (YES in step S73), the selection section 57 determines all the pieces of firmware 31, 32, 33, and 34 as backup holding targets (step S74).

When all the pieces of firmware 31, 32, 33, and 34 cannot be held as backup (NO in step S73), the selection section 57 performs the following determination. That is, the selection section 57 determines whether the firmware 31, 32, and 33 other than the application firmware 34 can be held in the second storage section 12b (step S75). If the three pieces of firmware 31, 32, and 33 can be held (YES in step S75), the firmware update section 53 brings the state detector 56 into operation. The state detector 56 reads the setting information (step S76), and determines whether access to the server apparatus 7 is permitted (step S77). In a case where the access to the server apparatus 7 is permitted (YES in step S77), the selection section 57 determines the three pieces of firmware 31, 32, and 33 as backup holding targets (step S78).

If the second storage section 12b does not have enough space to store the three pieces of firmware 31, 32, and 33 (NO in step S75), the selection section 57 determines that only the boot firmware 31 is to be backed up (step S79). Furthermore, if access to the server apparatus 7 is prohibited (NO in step S77), the selection section 57 determines only the boot firmware 31 as a backup holding target (step S79). By such backup holding determination (step S54), the contents of the firmware 8b to be stored as a backup in the second storage section 12b are determined. That is, the firmware update section 53 selects the firmware 8b to be stored as a backup in the second storage section 12b in accordance with the apparatus state.

Return to the flowchart of FIG. 7. The firmware update section 53 determines whether all the pieces of firmware 31, 32, 33, and 34 have been determined as backup storage targets by the backup storage determination (step S54) (step S55). When all the pieces of firmware 31, 32, 33, and 34 are to be held (YES in step S55), the firmware update section 53 reads all the pieces of firmware 31, 32, 33, and 34 stored in the first storage section 12a. Then, the firmware update section 53 stores all the firmware 31, 32, 33, and 34 in the second storage section 12b as a backup (step S56).

If all of the firmware 31, 32, 33, and 34 are not to be held (NO in step S55), the firmware update section 53 makes the following determination. That is, the firmware update section 53 determines whether the three pieces of firmware 31, 32, and 33 other than the application firmware 34 are to be held (step S57). If the three pieces of firmware 31, 32, and 33 are to be held (YES in step S57), the firmware update section 53 reads the three pieces of firmware 31, 32, and 33 from the first storage section 12a. Then, the firmware update section 53 stores the three pieces of firmware 31, 32, and 33 in the second storage section 12b as backup (step S58).

If the three pieces of firmware 31, 32, and 33 are not to be held (NO in step S57), the firmware update section 53 determines that only the boot firmware 31 is to be held. In this case, the firmware update section 53 reads the boot firmware 31 from the first storage section 12a. Then, the firmware update section 53 stores the boot firmware 31 in the second storage section 12b as a backup (step S59).

Thereafter, the firmware update section 53 gives the write prohibition setting to the second storage section 12b (step S60). Thus, the firmware update processing (step S48) ends.

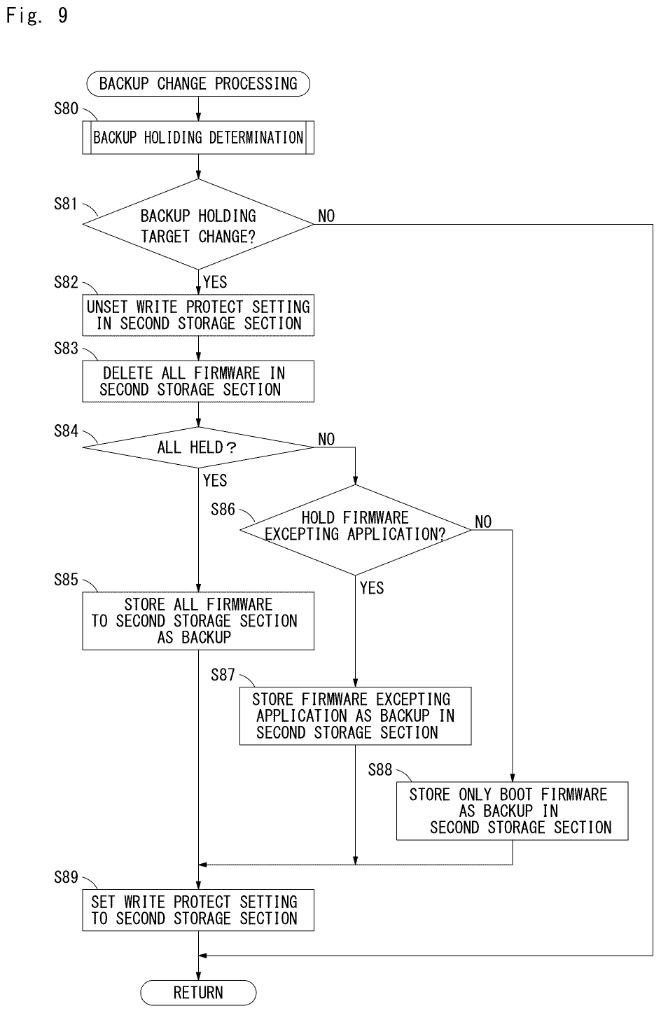

FIG. 9 is a flowchart illustrating an example of a detailed processing procedure of the backup change processing (step S49). When starting this processing, the firmware update section 53 executes backup holding determination (step S80). The detailed processing procedure of this backup holding determination (step S80) is the same as the flowchart illustrated in FIG. 8. That is, the firmware update section 53 determines the firmware 8b to be held for backup in accordance with the apparatus state.

Upon determining the target to be held for backup by the backup holding determination (step S80), the firmware update section 53 determines whether the target to be held for backup has been changed (step S81). When the target to be held in the backup has not been changed (NO in step S81), the processing performed by the firmware update section 53 ends. In this case, the firmware update section 53 does not change the firmware 8b held as a backup in the second storage section 12b.

On the other hand, when the backup holding target is changed (YES in step S81), the firmware update section 53 changes the firmware 8b stored as the backup in the second storage section 12b. In this case, the firmware update section 53 releases the write prohibition setting of the second storage section 12b (step S82). Subsequently, the firmware update section 53 deletes all the firmware 8b stored in the second storage section 12b (step S83).

Next, the firmware update section 53 determines whether all of the firmware 31, 32, 33, and 34 have been determined as backup holding targets by the backup holding determination (step S84). When all the pieces of firmware 31, 32, 33, and 34 are to be held (YES in step S84), the firmware update section 53 reads all the pieces of firmware 31, 32, 33, and 34 stored in the first storage section 12a. Then, the firmware update section 53 stores all the firmware 31, 32, 33, and 34 in the second storage section 12b as a backup (step S85).

If all of the firmware 31, 32, 33, and 34 are not to be held (NO in step S84), the firmware update section 53 makes the following determination. That is, the firmware update section 53 determines whether the three pieces of firmware 31, 32, and 33 other than the application firmware 34 are to be held (step S86). If the three pieces of firmware 31, 32, and 33 are to be held (YES in step S86), the firmware update section 53 reads the three pieces of firmware 31, 32, and 33 from the first storage section 12a. Then, the firmware update section 53 stores the three pieces of firmware 31, 32, and 33 in the second storage section 12b as backup (step S87).

If the three pieces of firmware 31, 32, and 33 are not to be held (NO in step S86), the firmware update section 53 determines that only the boot firmware 31 is to be held. In this case, the firmware update section 53 reads the boot firmware 31 from the first storage section 12a. Then, the firmware update section 53 stores the boot firmware 31 in the second storage section 12b as a backup (step S88).

Thereafter, the firmware update section 53 gives a write prohibition setting to the second storage section 12b (step S89). Thus, the backup change processing (step S49) ends.

By performing the above-described processing in the image processing apparatus 1, the firmware 8b stored as a backup in the second storage section 12b is switched according to the apparatus state of the image processing apparatus 1. For example, if the storage space of the second storage section 12b has changed at the time of activation of the image processing apparatus 1 due to addition or removal of an option, the firmware 8b to be stored as a backup changes in accordance with the storage space. Further, when the boot firmware 31, 32, 33, and 34 stored in the first storage section 12a is updated and the data amount of the firmware 8a is changed, the firmware 8b stored as a backup is also changed in accordance with the change in the data amount.

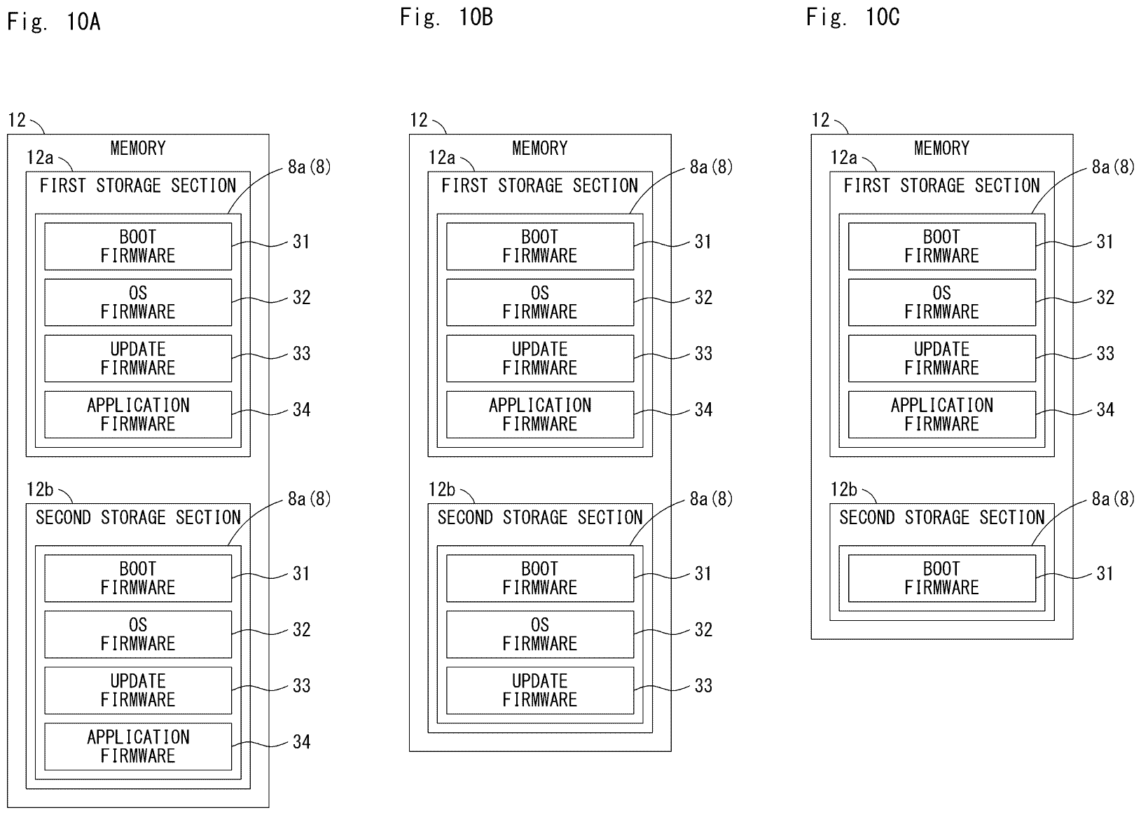

FIGS. 10A, 10B and 10C are conceptual drawings illustrating some examples of backup storage aspects of the firmware 8. FIG. 10A illustrates a mode in which all pieces of firmware 31, 32, 33, and 34 are stored as backup in the second storage section 12b. If the storage space of the second storage section 12b is large enough to store all of the multiple pieces of firmware 31, 32, 33, and 34, the firmware update section 53 backs up the firmware 8 in the storage mode illustrated in FIG. 10A. That is, the firmware update section 53 stores all of the multiple pieces of firmware 31, 32, 33, and 34 stored for activation in the first storage section 12a as a backup in the second storage section 12b. Thus, the image processing apparatus 1 can hold the backup of the firmware 8 in a completely duplicated state. Therefore, even when tampering is detected in any of the multiple firmware 31, 32, 33, and 34, the image processing apparatus 1 can restore normal firmware by using the firmware 31, 32, 33, and 34 held as backup.

FIG. 10B illustrates a mode in which three pieces of firmware 31, 32, and 33 are stored as backups in the second storage section 12b. When the storage space of the second storage section 12b is not large enough to store all of the multiple pieces of firmware 31, 32, 33, and 34, the firmware update section 53 may perform backup storage of the firmware 8 in a storage mode illustrated in FIG. 10B. That is, the firmware update section 53 stores the three pieces of firmware 31, 32, and 33 except for the application firmware 34 in the second storage section 12b as backup.

In this case, when tampering of any one of the three pieces of firmware 31, 32, and 33 whose backups are held is detected, the image processing apparatus 1 can restore normal firmware by using the pieces of firmware 31, 32, and 33 held as the backups.

However, when the application firmware 34 in the first storage section 12a is tampered, the image processing apparatus 1 cannot restore the application firmware 34 from the backup in the second storage section 12b. Therefore, the image processing apparatus 1 brings the firmware update section 53 into operation to acquire the application firmware 34 from the server apparatus 7 and restore it.

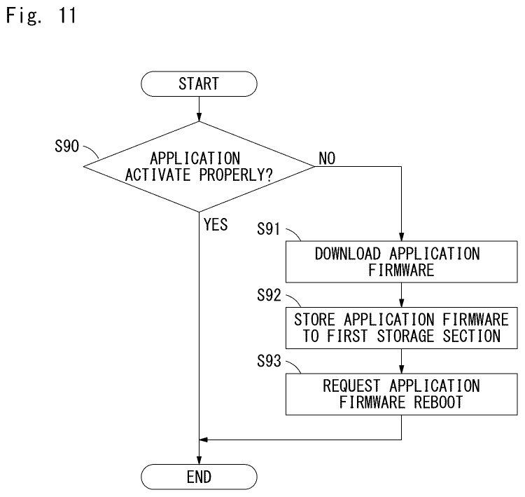

FIG. 11 is a flowchart illustrating a processing procedure in which the firmware update section 53 acquires the firmware 34 from the server apparatus 7. The firmware update section 53 determines whether the application 54 has been normally activated in the hardware processor 11 (step S90). For example, when an instruction to download the normal application firmware 34 is received from the restoration processor 42, the firmware update section 53 determines that the application 54 is not normally activated. In a case where the application 54 is not normally activated (NO in step S90), the firmware update section 53 accesses the server apparatus 7 and downloads the normal application firmware 34 from the server apparatus 7 (step S91). Subsequently, the firmware update section 53 overwrites and stores the normal application firmware 34 in the first storage section 12a (step S92). As a result, the application firmware 34 in the first storage section 12a is updated to normal firmware that has not been tampered with. Thereafter, the firmware update section 53 requests the basic operation controller 52 to restart the application firmware 34 (step S93). Accordingly, the basic operation controller 52 reads the application firmware 34 from the first storage section 12a and starts the application firmware 34. As a result, the application 54 is normally activated in the hardware processor 11. Next, the image processing apparatus 1 becomes ready to execute the job. Therefore, even in the storing form illustrated in 10B of the drawing, the image processing apparatus 1 can restore the firmware 8.

FIG. 10C illustrates a mode in which only the boot firmware 31 is stored as a backup in the second storage section 12b. If the second storage section 12b does not have a sufficient storage space, or if access to the server apparatus 7 is prohibited, the firmware update section 53 backs up and stores the firmware 8 in a storage manner illustrated in FIG. 10C. That is, the firmware update section 53 stores only the boot firmware 31 in the second storage section 12b as backup.

In this case, if tampering of the boot firmware 31 of which the backup is held is detected, the image processing apparatus 1 can restore the normal boot firmware 31 by using the boot firmware 31 held as the backup.

However, when the firmware 32, 33, and 34 other than the boot firmware 31 in the first storage section 12a is tampered, the image processing apparatus 1 cannot restore the firmware 32, 33, and 34 from the backup in the second storage section 12b. In this case, the activation processor 51 cannot normally activate the basic operation controller 52. Therefore, the activation processor 51 executes processing for displaying a notification screen indicating that the firmware 8 has been tampered with.

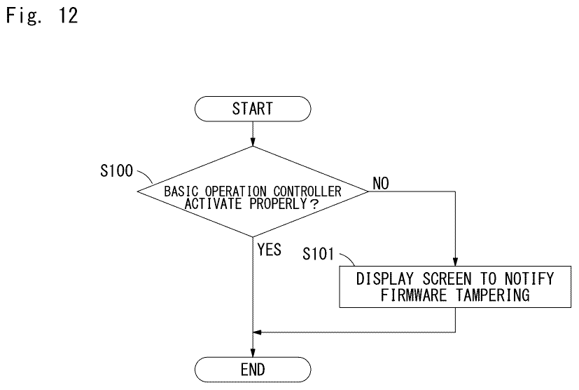

FIG. 12 is a flowchart illustrating an example of a processing procedure performed by the activation processor 51 when the legitimate OS firmware 32 cannot be activated. When starting this processing, the activation processor 51 determines whether the basic operation controller 52 has been activated normally (step S100). If the basic operation controller 52 has not been activated normally (NO in step S100), the activation processor 51 generates a notification screen indicating that the firmware 8 has been tampered with, and displays the notification screen on the display section 15 (step S101).

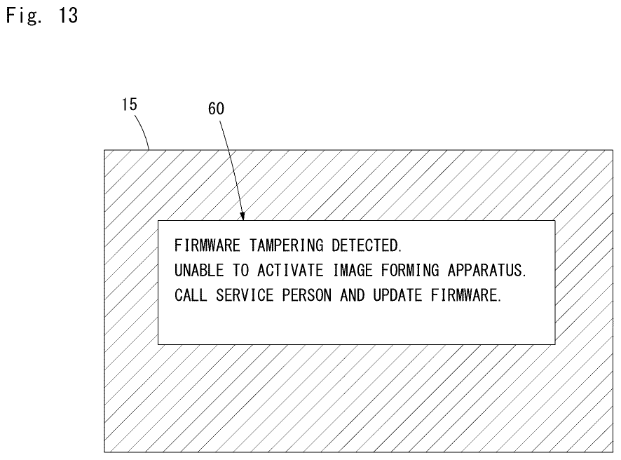

FIG. 13 is a view illustrating an example of a notification screen to be displayed on the display section 15. As illustrated in FIG. 13, a window 60 including a message indicating that the firmware 8 has been tampered with is displayed on the notification screen. The window 60 also includes a message indicating that it is necessary to call a service person and update the firmware 8. Therefore, the user can recognize that it is necessary to immediately make a service person call by confirming the display content of the notification screen. Therefore, if the firmware 8 of the image processing apparatus 1 is tampered with, the user can promptly take appropriate measures.

As described above, the image processing apparatus 1 according to the present embodiment selects the firmware 8 to be stored as a backup in the second storage section 12b in accordance with the apparatus status. Therefore, when the storage size of the second storage section 12b is relatively large, the image processing apparatus 1 can store all of the multiple pieces of firmware 31, 32, 33, and 34 in the second storage section 12b as a backup. Further, when the second storage section 12b has a relatively small storage space, the image processing apparatus 1 can store the firmware selected from the multiple firmware 31, 32, 33, and 34 in the second storage section 12b as a backup.

In particular, the image processing apparatus 1 may be allowed to access the external server apparatus 7 even when the second storage section 12b has a relatively small storage space. In this case, the image processing apparatus 1 stores the firmware 31, 32, and 33 necessary for downloading the firmware 8 from the server apparatus 7 in the second storage section 12b as a backup. In this case, upon detection of tampering with the firmware 31, 32, and 33 of which the backup is stored, the image processing apparatus 1 restores the firmware 31, 32, and 33 from the backup. Furthermore, if tampering with the firmware 34 whose backup is not stored is detected, the image processing apparatus 1 acquires the legitimate firmware 34 from the server apparatus 7 and restores the firmware 34. Therefore, even when the storage amount of the second storage section 12b is relatively small, the image processing apparatus 1 can appropriately restore all the firmware 31, 32, 33, and 34 and activate the firmware 31, 32, 33, and 34 in a state in which a job can be executed.

On the other hand, as an apparatus state of the image processing apparatus 1, there is a case where the firmware 31, 32, and 33 necessary for downloading the firmware 8 from the server apparatus 7 cannot be stored in the second storage section 12b as a backup. Furthermore, as the apparatus status of the image processing apparatus 1, access to the external server apparatus 7 different from the office environment 5 may be prohibited. In such a case, the image processing apparatus 1 stores only the firmware 31, which can notify the user that the firmware 8 has been tampered with, in the second storage section 12b as a backup. Therefore, when the firmware 8 is tampered with, the image processing apparatus 1 can appropriately notify the user that the firmware 8 is tampered with.

Therefore, the image processing apparatus 1 can effectively utilize the storage area of the memory 12 by automatically switching the firmware 8 to be stored for backup according to the apparatus state. Further, when the firmware 8 is tampered with, the image processing apparatus 1 can perform an appropriate processing in accordance with the backup holding state by using the firmware 8 stored as a backup.

### Second Embodiment

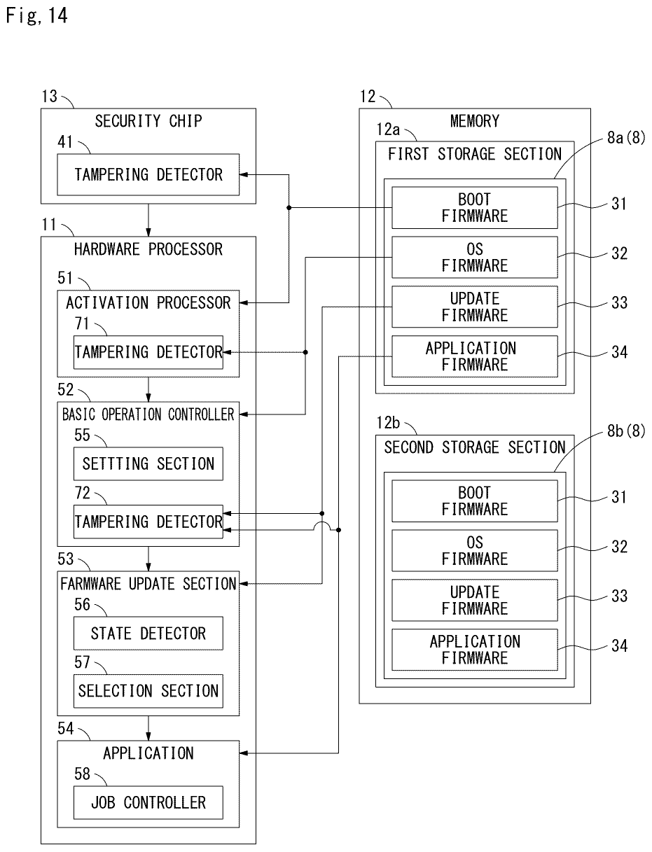

Next, a second embodiment of the present invention will be described. FIG. 14 is a block diagram illustrating a functional configuration of the controller 10 in the second embodiment. As in the first embodiment, the security chip 13 includes the tampering detector 41. When the power of the image processing apparatus 1 is turned on, the tampering detector 41 detects whether the boot firmware 31 has been tampered. In other words, the security chip 13 of the present embodiment detects only the presence or absence of tampering of the boot firmware 31 that is first activated in the image processing apparatus 1. When detecting that the boot firmware 31 has not been tampered with, the tampering detector 41 causes the hardware processor 11 to activate the boot firmware 31. Thus, the activation processor 51 functions in the hardware processor 11.

The activation processor 51 includes a tampering detector 71. The tampering detector 71 detects whether the OS firmware 32 to be activated next to the boot firmware 31 has been tampered. When detecting that the OS firmware 32 has not been tampered with, the tampering detector 71 causes the hardware processor 11 to activate the OS firmware 32 in the first storage section 12a. In contrast, upon detection of the tampering with the OS firmware 32, the tampering detector 71 deletes the OS firmware 32 from the first storage section 12a. Then, the tampering detector 71 stores the OS firmware 32 stored as a backup in the second storage section 12b into the first storage section 12a. That is, the tampering detector 71 detects tampering with the OS firmware 32 and performs recovery processing.

When the OS firmware 32 is activated by the hardware processor 11, the basic operation controller 52 functions. The basic operation controller 52 includes a tampering detector 72. The tampering detector 72 detects whether each of the update firmware 33 and the application firmware 34 to be activated next to the OS firmware 32 is tampered. When detecting that the update firmware 33 has not been tampered with, the tampering detector 72 causes the hardware processor 11 to activate the update firmware 33 in the first storage section 12a. Thus, the firmware update section 53 functions in the hardware processor 11. When detecting that the application firmware 34 has not been tampered with, the tampering detector 72 causes the hardware processor 11 to activate the application firmware 34 in the first storage section 12a. Thus, the application 54 functions in the hardware processor 11.

On the other hand, when the tampering detector 72 detects tampering of the update firmware 33, the tampering detector 72 deletes the update firmware 33 for activation from the first storage section 12a. Then, the tampering detector 72 stores the update firmware 33 stored as a backup in the second storage section 12b into the first storage section 12a. Thus, the tampered update firmware 33 is rewritten to the normal update firmware 33 that has not been tampered with. When the tampering detector 72 detects tampering of the application firmware 34, the tampering detector 72 deletes the application firmware 34 for activation from the first storage section 12a. Then, the tampering detector 72 stores the application firmware 34 stored as a backup in the second storage section 12b into the first storage section 12a. Thus, the tampered application firmware 34 is rewritten to the normal application firmware 34 that has not been tampered with. That is, the tampering detector 72 detects tampering with the update firmware 33 and the application firmware 34 and performs recovery processing.

As described above, the image processing apparatus 1 according to the present embodiment is configured such that each of the multiple pieces of firmware 31, 32, 33, and 34 sequentially activated in a stepwise manner in the hardware processor 11 performs tampering detection and restoration processing on firmware to be activated next. Other configurations of the image processing apparatus 1 are the same as those of the first embodiment. Therefore, the image processing apparatus 1 of the present embodiment has the same advantageous effects as those of the first embodiment.

### Modification Example

Hereinabove, a preferred embodiment of the present invention has been described. However, the present invention is not limited to the content described in the above embodiment. That is, various modification examples can be applied to the present invention with respect to the above-described embodiment.

For example, the above embodiment is described with the example in which the update firmware 33 is activated by the hardware processor 11 at the time of activation of the image processing apparatus 1. However, the firmware update section 53 may be activated when tampering of the firmware is detected and it is necessary to download legitimate firmware from the server apparatus 7 and update the firmware in the first storage section 12a.

In addition, in the above-described embodiment, an example has been described in which, after the firmware 31, 32, 33, and 34 is stored in the second storage section 12b, tampering of the firmware 31, 32, 33, and 34 is prevented by giving the write prohibition setting to the second storage section 12b. However, there is a possibility that the writing prohibition setting of the second storage section 12b is fraudulently released. In this case, not only the firmware 31, 32, 33, and 34 of the first storage section 12a but also the firmware 31, 32, 33, and 34 of the second storage section 12b may be tampered. Therefore, when the image processing apparatus 1 reads the firmware 31, 32, 33, and 34 for backup from the second storage section 12b, the image processing apparatus 1 may perform tampering detection on each of the firmware 31, 32, 33, and 34 read from the second storage section 12b. Further, the timing at which tampering detection of the firmware 31, 32, 33, and 34 for backup is performed is not limited to the timing at which the firmware 31, 32, 33, and 34 is read from the second storage section 12b. For example, tampering detection may be performed when the firmware 31, 32, 33, and 34 for backup is read from the first storage section 12a after being copied to the first storage section 12a.

Furthermore, in the above-described embodiment, the case where the firmware 8 is stored in the memory 12 of the controller 10 has been illustrated. However, the storage device in which the firmware 8 is stored is not limited to the memory 12. For example, the firmware 8 may be stored in the storage device 24.

Furthermore, in the above-described embodiment, the case where the firmware 8a for activation and the firmware 8b for backup are stored in the same memory 12 has been illustrated. However, the firmware 8a for activation and the firmware 8b for backup may be stored in storage devices different from each other.

In the above-described embodiment, the firmware 8 installed in the image processing apparatus 1 includes four pieces of firmware, i.e., the boot firmware 31, the OS firmware 32, the update firmware 33, and the application firmware 34. However, the firmware 8 installed in the image processing apparatus 1 may include firmware other than the above-described firmware.

Furthermore, in the above-described embodiment, an example has been described in which the storage space of the second storage section 12b and the setting of permission or prohibition of access to the server apparatus 7 are determined as the apparatus status of the image processing apparatus 1. However, the present invention is not limited thereto, and the image processing apparatus 1 may determine an apparatus status other than the storage space of the second storage section 12b and the setting of access to the server apparatus 7 and select the firmware 8 to be stored as backup.

The firmware 8 described in the above embodiment is stored in the image processing apparatus 1 in advance. However, the firmware 8 that is a dedicated program for the image processing apparatus 1 is not necessarily limited to that stored in advance in the image processing apparatus 1.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus, comprising:
a first storage section that stores multiple pieces of firmware to be started in stages;
a second storage section that stores firmware selected from the multiple pieces of firmware as a backup; and
a hardware processor that:
detects tampering of each of the multiple pieces of firmware stored in the first storage section, and
restores the tampered firmware by using the firmware stored in the second storage section in a case where the tampering of the firmware stored in the first storage section is detected, wherein
the hardware processor selects, according to an apparatus state, the firmware to be stored as backup in the second storage section.

2. The image processing apparatus according to claim 1, wherein
the second storage section stores the firmware selected by the hardware processor in a non-rewritable storage area.

3. The image processing apparatus according to claim 1, wherein
the hardware processor selects the firmware to be stored as a backup in the second storage section from among the multiple firmware based on a storage capacity of the second storage section.

4. The image processing apparatus according to claim 1, wherein
the hardware processor selects the firmware to be stored as backup in the second storage section from among the multiple pieces of firmware based on a change in data amount of the multiple pieces of firmware.

5. The image processing apparatus according to claim 1, wherein
the hardware processor sets in advance prohibition or permission to acquire the multiple pieces of firmware from an external apparatus via a network, and selects the firmware to be stored as a backup in the second storage section based on the setting of prohibition or permission.

6. The image processing apparatus according to claim 5, wherein
when acquisition of firmware from the external apparatus is prohibited, the hardware processor selects, as firmware to be stored as a backup in the second storage section, the firmware capable of notifying that tampering of the firmware has been detected.

7. The image processing apparatus according to claim 5, wherein
when acquisition of firmware from the external apparatus is permitted, the hardware processor selects the firmware necessary for acquiring the firmware from the external apparatus and updating the firmware as the firmware to be stored as a backup in the second storage section.

8. The image processing apparatus according to claim 3, wherein
the hardware processor selects all of the multiple pieces of firmware when the second storage section can store all of the multiple pieces of firmware.

9. The image processing apparatus according to claim 1, wherein
the hardware processor updates the multiple pieces of firmware stored in the first storage section, selects firmware to be stored as backup in the second storage section when the firmware in the first storage section is updated, and changes the firmware to be stored in the second storage section.

10. The image processing apparatus according to claim 1, wherein
the hardware processor determines whether an apparatus state has changed at the time of activation, and when the apparatus state has changed, selects firmware to be stored as backup in the second storage section and changes the firmware to be stored in the second storage section.

11. A method for storing firmware as a backup in an image processing apparatus, the image processing apparatus comprising:
a first storage section that stores multiple firmware to be started up in stages;
a second storage section that stores, as a backup, a firmware selected from among the multiple firmware; and
a hardware processor that detects tampering with each of the multiple firmware stored in the first storage section and, upon detection of tampering with a firmware, restores the tampered firmware using the firmware stored in the second storage section, wherein
the method comprises:
selecting, from among the multiple firmware, firmware to be stored as a backup in the second storage section in accordance with an apparatus state; and
changing firmware stored as backup in the second storage section according to the selection result.

12. A non-transitory computer-readable recording medium storing a program executed in an image processing apparatus, the image processing apparatus comprising:
a first storage section that stores multiple firmware to be started up in stages;
a second storage section that stores, as a backup, a firmware selected from among the multiple firmware; and
a hardware processor that detects tampering with each of the multiple firmware stored in the first storage section and, upon detection of tampering with a firmware, restores the tampered firmware using the firmware stored in the second storage section, wherein
the program causes the hardware processor to perform:
selecting, from among the multiple firmware, firmware to be stored as a backup in the second storage section in accordance with an apparatus state; and
changing firmware stored as backup in the second storage section according to the selection result.
